(19) United States
(12) Patent Application Publication
(10) Pub. No.: US 2024/0354718 A1
(43) Pub. Date: Oct. 24, 2024

(54) UTILIZING UNIQUE MESSAGING ACCOUNTS TO EXTRACT TRANSACTION DATA FOR CARD-BASED TRANSACTIONS

(71) Applicant: Marqeta, Inc., Oakland, CA (US)

(72) Inventors: Hongtao Zhang, San Francisco, CA (US); Amit Jagannath Magar, San Jose, CA (US); Mark Daniel Cline, Alameda, CA (US)

(21) Appl. No.: 18/304,126

(22) Filed: Apr. 20, 2023

(51) Int. Cl. G06Q 20/02; G06Q 20/16; G06Q 20/34; G06Q 20/40

(52) U.S. Cl. CPC G06Q 20/02; G06Q 20/16; G06Q 20/34; G06Q 20/401

(57) ABSTRACT

This disclosure describes methods, non-transitory computer readable storage media, and systems that securely retrieve and extract data for card-based transactions from various sources via a multi-branch processing pipeline. Specifically, in some embodiments, the disclosed systems assign a unique messaging account to a payment card of a payment account for retrieval of digital messages corresponding to transactions initiated by the payment card. In one or more embodiments, the disclosed systems determine a first subset of data for a card-based transaction processed through a payment network. The disclosed systems also determine a second subset of transaction data in response to receiving a digital message at the unique messaging account assigned to the payment card in response to the card-based transaction. In some embodiments, the disclosed systems generate a mapping between the first and second subsets of transaction data within a transaction database for performing downstream operations.

### BACKGROUND

Improvements in computing technology have led to an increase in the use of card-based payment transactions and electronic payment transactions. The prevalence of card-based/electronic payment transactions has also led to many entities providing increased access to payment cards (e.g., credit cards or debit cards) for consumers to use with merchants and other recipients. In connection with providing access to payment cards to use in card-based payment transactions and electronic payment transactions, some entities provide a variety of options for funding card-based payment transactions or other parameters of accounts associated with the payment cards. Additionally, entities involved in processing such transactions are typically restricted to transmitting, storing, and otherwise handling specific data types according to Payment Card Industry (“PCI”) standards for secure processing, thereby limiting the data types that computing systems can handle during the processing operations.

Increasing the number of options available for payment card accounts given the restrictions on the types and methods of handling transaction data, however, also increases the complexity of managing the payment card accounts or processing transactions involving the payment card accounts. Conventional systems that provide access to payment card accounts often lack the requisite data to ensure accurate and efficient management of payment cards and accounts due to the increasing options made available and restrictions. Thus, conventional systems are often unable to accurately and efficiently moderate payment card options, reconcile transaction details to ensure that items indicated in transaction data are accurate, and facilitate transaction processing without increasing security risks due to utilizing transaction data available through conventional channels.

### SUMMARY

This disclosure describes one or more embodiments of methods, non-transitory computer readable media, and systems that solves one or more of the foregoing problems (in addition to providing other benefits). The disclosed systems utilize a card-specific messaging account (e.g., a unique email account or unique text messaging account) to extract additional data for card-based payment transactions via a multi-branch processing pipeline. In one or more embodiments, the disclosed systems assign a unique messaging account to a payment card associated with a payment account. Additionally, in response to a card-based transaction initiated using the payment card, the disclosed systems determine a first subset of transaction data corresponding to the card-based transaction via a first processing pipeline branch and a second subset of transaction data corresponding to the card-based transaction from a digital message received at the unique messaging account via a second processing pipeline branch. Furthermore, in some embodiments, the disclosed systems generate a mapping between the second subset of transaction data of the digital message and the first subset of transaction data within a transaction database for performing downstream operations. By extracting multiple subsets of transaction data from multiple sources in separate processing pipeline branches, the disclosed systems provide accurate, efficient, and secure consolidation and monitoring of data for card-based transactions and management of payment cards.

### BRIEF DESCRIPTION OF THE DRAWINGS

The detailed description refers to the drawings briefly described below.

FIG. 1 illustrates a block diagram of a system environment in which a transaction data extraction system is implemented in accordance with one or more implementations.

FIG. 2 illustrates a diagram of an overview of the transaction data extraction system processing transaction data from multiple sources in accordance with one or more implementations.

FIG. 3 illustrates a diagram of the transaction data extraction system receiving and consolidating a plurality of subsets of transaction data via a multi-branch processing pipeline in accordance with one or more implementations.

FIG. 4 illustrates a diagram of the transaction data extraction system generating a mapping between multiple subsets of transaction data in accordance with one or more implementations.

FIG. 5 illustrates a diagram of the transaction data extraction system utilizing consolidated transaction data to determine card program modifications in accordance with one or more implementations.

FIG. 6 illustrates a diagram of the transaction data extraction system utilizing transaction data to determine authorization of a card-based transaction for a category-restricted payment account in accordance with one or more implementations.

FIGS. 7A-7B illustrate two payment account interfaces for monitoring transaction data for a payment card account in accordance with one or more implementations.

FIG. 8 illustrates a flowchart of a series of acts for consolidating transaction data from multiple sources in accordance with one or more implementations.

FIG. 9 illustrates a block diagram of an exemplary computing device in accordance with one or more implementations.

### DETAILED DESCRIPTION

This disclosure describes one or more embodiments of a transaction data extraction system that utilizes a unique messaging account to acquire and extract transaction data from a plurality of sources in a multi-branch processing pipeline. In particular, the transaction data extraction system receives transaction data from multiple sources and generates a mapping between data subsets to consolidate transaction data in a transaction database. For example, in some embodiments, the transaction data extraction system assigns a unique messaging account to a payment card and receives digital messages at the unique messaging account for card-based transactions initiated with the payment card. Additionally, the transaction data extraction system consolidates transaction data from digital messages received at the unique messaging account with other transaction data corresponding to the card-based transaction, such as data received from a payment network when processing the card-based transaction. The transaction data extraction system can utilize the consolidated transaction data to perform additional operations, such as managing payment card management via customization of card programs, enabling/disabling transaction types, or authorizing use of and/or modifications to category-restricted payment accounts.

As mentioned, in one or more embodiments, the transaction data extraction system determines a first subset of transaction data corresponding to a card-based transaction initiated by a payment card via a first processing pipeline branch. For example, in some embodiments, the transaction data extraction system determines the first subset of transaction data during processing of the card-based transaction via a payment network. In one or more embodiments, the transaction data extraction system receives the first subset of transaction data within one or more transaction messages from the payment network.

The transaction data extraction system also determines a second subset of transaction data corresponding to the card-based transaction via a second processing pipeline branch. For instance, the transaction data extraction system receives a digital message for the card-based transaction at a unique messaging account assigned to (or otherwise associated with) the payment card. In response, in one or more embodiments, the transaction data extraction system extracts the second subset of transaction data from the digital message. Additionally, the transaction data extraction system generates a mapping between the second subset transaction data and the first subset of transaction data within a transaction database.

Additionally, in one or more embodiments, the transaction data extraction system monitors transaction data, obtained and consolidated as described herein, to track and administer usage of a payment card associated with a payment account. For example, in some embodiments, the transaction data extraction system utilizes consolidated transaction data to limit transaction processing for a payment card in connection with specific types of products, merchants, and so forth. Relatedly, in some embodiments, the transaction data extraction system considers consolidated transaction data to reconcile transaction information (e.g., prior to clearing funds for a previously authorized transaction) or for closing on transactions for purchase orders, etc. Moreover, in some embodiments, the transaction data extraction system utilizes the consolidated transaction data to monitor card activity and detect fraudulent activity or potential security risks associated with the payment account. The transaction data extraction system can also utilize consolidated transaction data to provide management of category-restricted payment accounts, including authorization of payment transactions involving such payment accounts and modifications to such payment accounts based on the consolidated transaction data.

As mentioned, conventional systems are limited to the use of a small, fixed set of transaction data for certain types of payment transactions due to the diversity of systems involved, technological limitations, batch orientation of card payments, and/or access controls that restrict direct access to information associated with card-based transactions. For example, computing systems involved in card-based transactions are typically required to transmit and store data according to a set of rules dictated by PCI standards. For instance, computing systems that process card-based transactions are required to implement certain access controls, network security protocols, and device operating protocols to securely handle specific types of transaction data. Accordingly, in part due to limited access to transaction data based on the required access controls, conventional systems lack flexibility and efficiency needed to accurately monitor and administer payment cards and/or payment accounts. Conventional systems thus often use of a small, fixed set of transaction data during transaction processing, which limits the ability of the conventional systems to perform certain downstream controls and operations.

Additionally, because conventional processing pipelines are limited to small, fixed sets of data from payment networks (e.g., including payment card networks), some conventional systems augment transaction data via additional sources that introduce security or privacy issues. In particular, some conventional systems request additional data from cardholders to supplement transaction data via email accounts of the cardholders. Such methods of augmenting transaction data, however, requires cardholders to give access/consent to the conventional systems to access their personal emails. This can trigger certain privacy/security concerns related to handling the personal information of the cardholder. Furthermore, such conventional systems can also introduce inaccuracies in the augmented transaction data because the conventional systems rely on cardholders providing the correct data for the appropriate transactions.

The disclosed transaction data extraction system provides a number of benefits over conventional systems. For example, the transaction data extraction system improves the flexibility and efficiency of computing systems that manage and process transactions involving payment card accounts. In contrast to existing systems that cannot access and/or monitor transaction data from alternative sources, the transaction data extraction system retrieves and consolidates transaction data from a plurality of different sources in a multi-branch processing pipeline. Specifically, by leveraging unique messaging accounts assigned to payment cards for automatically supplementing transaction data with additional data types, the transaction data extraction system provides increased access to information of particular pertinence to monitoring and administration of payment card accounts and processing transactions involving the payment card accounts. Furthermore, the transaction data extractions system can utilize the additional transaction data to perform (or enable) additional downstream operations associated with payment cards, such as customization of card account characteristics and capabilities.

Additionally, by generating a mapping between each digital message received and each corresponding card-based transaction, the transaction data extraction system increases accuracy and efficiency of data monitoring compared to existing systems. In contrast to conventional systems that rely on manually provided data to supplement transaction data, the transaction data extraction system can verify the origin and validity of additional transaction data associated with card-based transactions. In particular, by assigning a unique messaging account to a payment card, the transaction data extraction system can automatically receive transaction data and additional transaction data in a multi-branch processing pipeline. Thus, the transaction data extraction system can verify the accuracy of the transaction data and additional transaction data for recording purposes and downstream operations.

Furthermore, the transaction data extraction system improves the security of computing systems that process transactions associated with payment card accounts. For instance, in contrast to existing systems that require access to personal emails, the transaction data extraction system receives and parses data from digital messages for card-based transactions without requiring access to personal accounts associated with the corresponding payment card and/or payment account. Specifically, by assigning a unique messaging account to each individual payment card, the transaction data extraction system enables receipt of digital messages for card-based transactions at a secure location without requiring access to additional applications/data sources or additional permissions from card users.

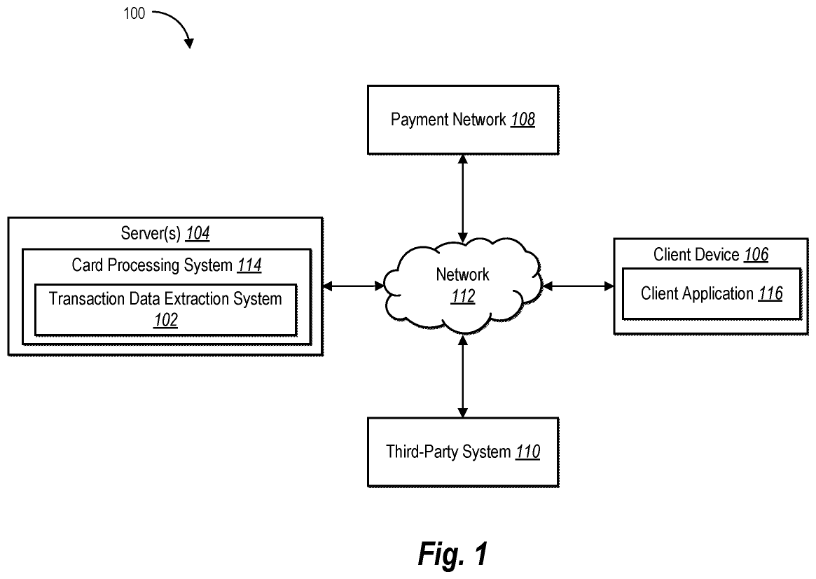

Turning now to the figures, FIG. 1 includes an embodiment of a system environment 100 in which a transaction data extraction system 102 operates. In particular, the system environment 100 includes server(s) 104, a client device 106, a payment network 108, and at least one third-party system 110 in communication via a network 112. FIG. 1 illustrates the transaction data extraction system 102 as part of a card processing system 114. Moreover, in one or more embodiments, the client device 106 includes a client application 116.

As shown in FIG. 1, the server(s) 104 include or host the card processing system 114. The server(s) 104 communicate with one or more other components in the system environment 100 to facilitate processing of card-based payment transactions and electronic payment transactions involving payment card accounts. Specifically, the card processing system 114 includes a processing application that authorizes/declines card-based payment transactions involving a payment card account, such as by communicating with the third-party system 110. As used herein, the terms “payment card account” and “payment account” refer to a card-based payment account associated with a physical card or a digital card. To illustrate, a payment card account includes a debit account or a credit account for processing payment transactions via the use of a physical card or a digital card (e.g., in a digital wallet).

In one or more embodiments, the card processing system 114 communicates with payment network 108 to initiate/process card-based payment transactions (e.g., in response to the client device 106 providing a transaction request to the card processing system 114). In one or more embodiments, the payment network 108 includes one or more payment gateway systems, one or more payment card networks (e.g., VISA, MASTERCARD), and/or one or more card issuer systems (e.g., bank issuers) to process electronic card transactions in connection with the card processing system 114. The payment network 108 includes one or more servers to generate, store, and transmit data associated with initiating and processing electronic card transactions via the card processing system 114. In some embodiments, the card processing system 114 communicates with one or more additional participant systems including, but not limited to, the third-party system 110 to initiate/process transactions involving the payment card accounts. In one or more embodiments, the third-party system 110 manages funds or ledgers associated with the payment card accounts.

As used herein, the term “transaction” refers to a computer-based processing operation involving a payment card account. To illustrate, a transaction can include a card-based payment transaction to transfer funds from a payment card account to a recipient account (or vice-versa). Additionally, a transaction can include an operation to access information associated with a payment card account including, but not limited to, a personal identification number (“PIN”), account credentials, account details (e.g., available balance), withdrawals/deposits, or other operations that touch data (e.g., a ledger) stored for a payment card account.

In one or more embodiments, in connection with processing transactions involving payment card accounts, the card processing system 114 utilizes the transaction data extraction system 102 to obtain, extract, consolidate, and/or store transaction data related to card-based transactions. For instance, the transaction data extraction system 102 communicates with the payment network 108 (e.g., one or more payment card networks) to receive at least some transaction data associated with a card-based transaction processed via the payment network 108, the card-based transaction being associated with a payment card that initiated the card-based transaction. Additionally, the transaction data extraction system 102 communicates with the third-party system 110 to receive additional transaction data from, in some cases, a digital message (e.g., a digital invoice) sent to a unique messaging account assigned to the payment card that initiated the card-based transaction. Furthermore, the transaction data extraction system 102 consolidates and stores the transaction data retrieved from the payment network 108, the third-party system 110, and/or other sources in accordance with one or more embodiments disclosed herein. The transaction data extraction system 102 and/or the card processing system 114 can also utilize the consolidated transaction data to perform downstream operations.

As used herein, the term “digital message” includes an electronic communication including via an electronic communication channel. Specifically, a digital message includes an electronic message provided to a messaging account via one or more electronic communication channels and/or from one or more sources in response to initiating a card-based transaction. To illustrate, a digital message includes, but is not limited to, an email, a text message, or an instant message. In some embodiments, a digital message is, or includes, a digital invoice with transaction data associated with a card-based transaction.

In one or more embodiments, the transaction data extraction system 102 and/or the card processing system 114 provides an application programming interface (“API”) for systems or devices in the system environment 100 to perform operations/transactions associated with payment card accounts. For instance, the transaction data extraction system 102 and/or the card processing system 114 provides an API with tools for managing payment card accounts, card programs associated with the payment card accounts, and managing messaging accounts (e.g., assigned to each payment card associated with a payment card account). Additionally, in some embodiments, the transaction data extraction system 102 provides an API for the third-party system 110 to determine messaging accounts associated with payment cards and provide additional data in connection with card-based transactions.

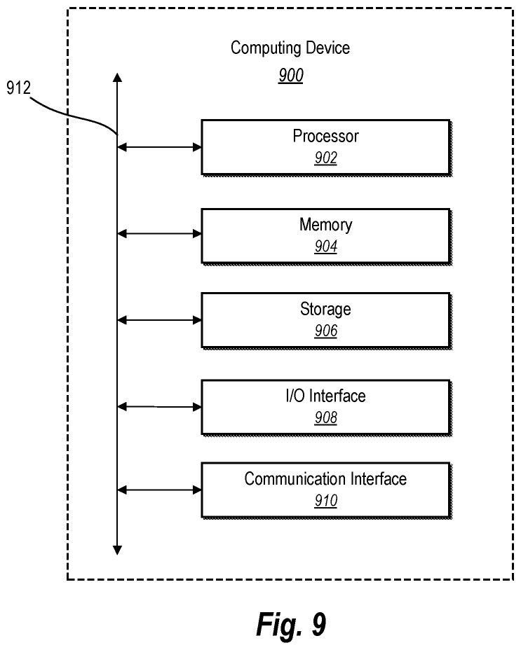

In one or more embodiments, the server(s) 104 include a variety of computing devices, including those described below with reference to FIG. 9. For example, the server(s) 104 includes one or more servers for storing and processing data associated with payment card accounts. In some embodiments, the server(s) 104 also include a plurality of computing devices in communication with each other, such as in a distributed storage environment. In some embodiments, the server(s) 104 communicate with a plurality of issuing systems and issuing system devices or other systems and devices of one or more entities based on established relationships between the card processing system 114, the transaction data extraction system 102, and the one or more entities. To illustrate, the server(s) 104 communicate with various entities or systems including financial institutions (e.g., issuing banks associated with payment cards via the payment network 108), payment card networks associated with processing payment transactions involving payment card accounts, payment cards, payment gateways, merchant systems, client devices, or other systems.

In addition, in one or more embodiments, the card processing system 114 and/or the transaction data extraction system 102 are implemented on one or more servers. For example, the card processing system 114 and/or the transaction data extraction system 102 can be partially or fully implemented on a plurality of servers. To illustrate, the card processing system 114 and the transaction data extraction system 102 can be implemented in a distributed environment. In one or more embodiments, each server handles requests for managing accounts or processing payment transactions. Furthermore, in one or more embodiments, the card processing system 114 and/or the transaction data extraction system 102 include or communicate with a plurality of servers in a distribute database for storing consolidated transaction data associated with card-based transactions.

In one or more embodiments, the client device 106 includes a computing device that initiates electronic payment transactions via the payment network 108. For example, the client device 106 includes a user device, such as a smartphone, desktop computer, laptop, or other computing device that enables electronic payment transactions with one or more entities (e.g., via web applications or standalone applications). In some embodiments, the client device 106 includes a recipient device that hosts a web application or standalone applications and communicates with the payment network 108 to initiate electronic payment transactions. In alternative examples, the client device 106 includes a point-of-sale device including a card reader, chip reader, or other device to initiate electronic payment transactions between a sending user and a recipient user.

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the card processing system 114, the transaction data extraction system 102, the client device 106, and the third-party system 110 communicate via the network 112 using one or more communication platforms and technologies suitable for transporting data and/or communication signals, including any known communication technologies, devices, media, and protocols supportive of data communications, examples of which are described with reference to FIG. 9. Additionally, in one or more embodiments, one or more of the various components of the system environment 100 communicate using protocols for financial information communications such as PCI standards or other protocols.

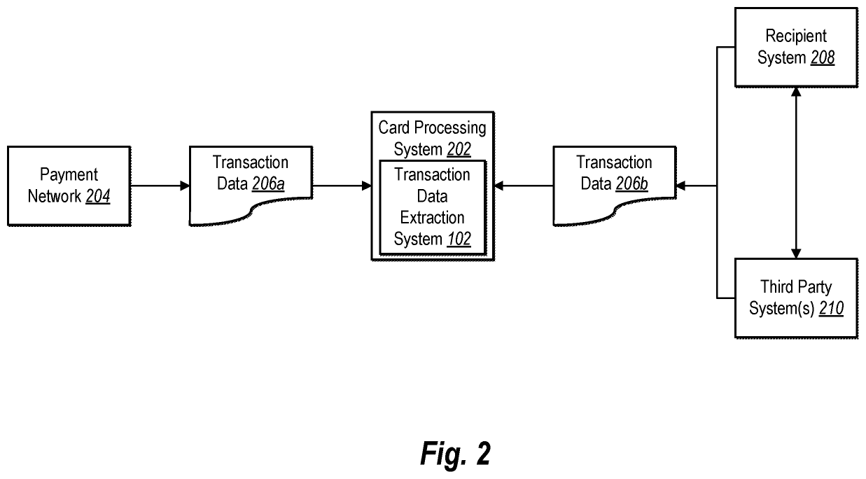

As mentioned, in one or more embodiments, the transaction data extraction system 102 retrieves and consolidates transaction data associated with card-based transactions from various sources in a multi-branch processing pipeline. For example, FIG. 2 illustrates an overview of the transaction data extraction system 102 consolidating transaction data 206a and transaction data 206b received by a card processing system 202 (which includes the transaction data extraction system 102) from multiple sources. In particular, FIG. 2 illustrates that the card processing system 202 receives the transaction data 206a from a payment network 204 and the transaction data 206b from one or more of a recipient system 208 (i.e., a computer system of the payment recipient for a particular card-based transaction) and/or third party system(s) 210 (i.e., other sources of transaction data such as an acquirer system or a user device).

In one or more embodiments, the transaction data 206a includes a first subset of transaction data related to the card-based transaction, and the transaction data 206b includes a second subset of transaction data related to the card-based transaction. For example, the transaction data 206a includes, but is not limited to, a transaction amount/time, one or more identifiers of entities involved in the card-based transaction, location information, tax information, or clearing information for authorizing the card-based transaction. Additionally, the transaction data 206b includes at least some of the data included in the transaction data 206a and at least some data not included in the transaction data 206a. To illustrate, the transaction data 206b includes, but is not limited to, a transaction amount/time, one or more identifiers of entities involved in the card-based transaction, location information, itemized product information, product categories/classifications, data lineage information (e.g., identity of a source from which data was received), or other information not available from the payment network 204.

In one or more embodiments, as illustrated in FIG. 2, the card processing system 202 is in communication with the payment network 204 for processing data associated with electronic payment transactions. Specifically, the card processing system 202 communicates with the payment network 204 to receive and store data associated with specific events in an electronic payment transaction involving a request to transfer funds from a payment account to a recipient account. For example, the card processing system 202 communicates with one or more systems in the payment network 204 (e.g., a payment gateway system, a payment card network, or an issuing bank system) and/or one or more additional entities (e.g., a merchant system) to send and receive data associated with an electronic payment transaction between a funding user and a recipient user.

In particular, FIG. 2 illustrates the card processing system 202 in communication with the payment network 204 to process a transaction initiated by a particular payment card. In other words, for a card-based transaction, the card processing system 202 receives the transaction data 206a in one or more transaction messages from the payment network 204. In some embodiments, the transaction data extraction system 102 generates a transaction log from the transaction message(s) received from the payment network 204, the transaction log comprising the transaction data 206a.

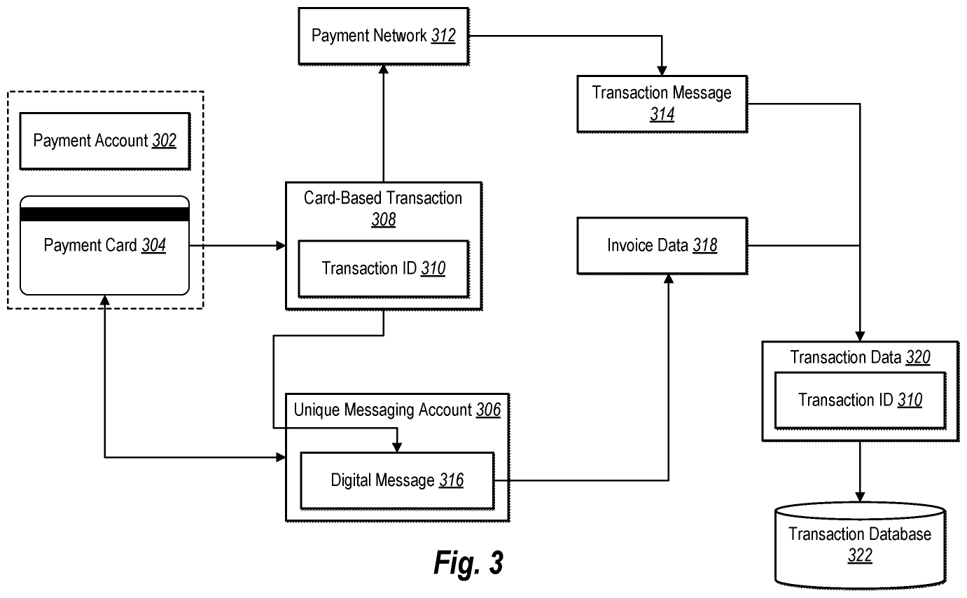

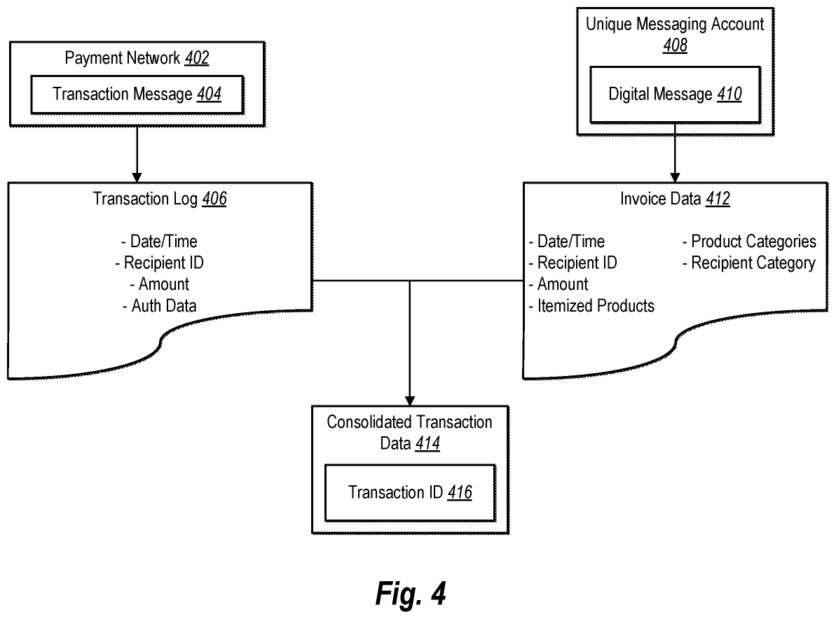

In addition, as shown in FIG. 2, the card processing system 202 is in communication with the recipient system 208 and/or the third party system(s) 210 to receive additional data corresponding to the card-based transaction (e.g., as further described below in relation to FIGS. 3-4). For example, in some implementations, the card processing system 202 receives a digital message (e.g., a digital invoice) comprising the transaction data 206b from either or both of the recipient system 208 and the third party system(s) 210. Third party system(s) 210, for example, can include any additional systems in communication with the recipient system 208 from which additional data (e.g., a digital invoice) are provided, such as but not limited to third party systems that provide payment transaction equipment and services to various merchants.

As further described below, in one or more embodiments, the transaction data extraction system 102 consolidates the transaction data 206a received from the payment network 204 and the transaction data 206b received from the recipient system 208 and/or the third party system(s) 210. For example, in one or more embodiments, the transaction data extraction system 102 generates a mapping, within a transaction database, between the transaction data 206a and the transaction data 206b. In some embodiments, for instance, the transaction data extraction system 102 associates a transaction identification number with the transaction data 206a and the transaction data 206b.

As mentioned, in one or more embodiments, the transaction data extraction system 102 retrieves and consolidates data from multiple sources in a multi-branch processing pipeline within a transaction database. For example, FIG. 3 illustrates the transaction data extraction system 102 extracting and consolidating transaction data 320 from a transaction message 314 and invoice data 318 according to one or more embodiments. Specifically, FIG. 3 illustrates that the transaction data extraction system 102 processes the transaction message 314 via a first processing pipeline branch and the invoice data 318 via a second processing pipeline branch.

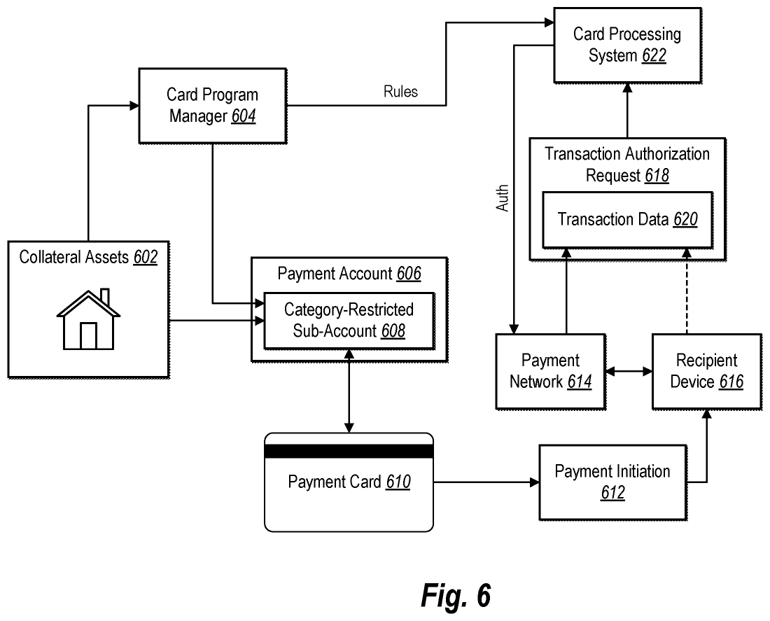

As shown in FIG. 3, a payment account 302 includes at least one payment card 304 for initiating card-based transactions. The payment account 302 is not necessarily limited to the payment card 304, and can include multiple payment cards or multiple sub-accounts such as checking, savings, credit lines and other sub-accounts. In one or more embodiments, each sub-account of the payment account 302 is associated with a separate payment card. Alternatively, a single payment card (e.g., the payment card 304) may be associated with more than one sub-account. For example, the payment account 302 can include payment cards that are specifically linked to one or more particular sub-accounts, such as a debit card linked to a checking account, a category-restricted debit card linked to a tax-deferred savings account, a category-restricted credit card linked to a specialized line of credit (e.g., as discussed below in relation to FIG. 6), a standard credit card, and so forth.

In additional embodiments, the payment account 302 is associated with a plurality of users authorized to utilize one or more of the payments cards and/or one or more sub-accounts associated with the payment account 302. For instance, a third-party system can provide a card program that associates a plurality of user accounts with the payment account 302. Additionally, separate sub-accounts of the payment account 302 may be associated with separate user accounts, such that each sub-account of the payment account 302 has a corresponding payment card (e.g., the payment card 304) associated with a specific user account. In additional embodiments, the third-party system and/or a card processing system including the transaction data extraction system 102 associates a plurality of user accounts with the payment card 304.

As illustrated, the transaction data extraction system 102 assigns a unique messaging account 306 to the payment card 304. For example, the unique messaging account 306 can include a dedicated email address, a dedicated text messaging number, a dedicated instant messaging account, or any messaging account that is dedicated to the payment card 304. In some embodiments, the unique messaging account 306 is also dedicated to a particular user of the payment card 304. In implementations wherein the payment account 302 includes multiple payment cards, the transaction data extraction system 102 can assign a unique messaging account to each payment card associated with the payment account 302. In additional embodiments, the transaction data extraction system 102 generates the unique messaging account 306 in response to determining that the payment account 302 has permissions for using invoice data to augment transaction data for card-based transactions. To illustrate, the transaction data extraction system 102 generates the unique messaging account 306 based on a selected setting providing permission/consent to the transaction data extraction system 102 to generate the unique messaging account 306 and provide such information to recipient systems.

In one or more embodiments, the transaction data extraction system 102 also utilizes information associated with a particular user/cardholder to generate the unique messaging account 306. For example, in response to determining that a particular card is associated with a plurality of authorized users, the transaction data extraction system 102 can obtain a user identifier for a particular user (e.g., a device ID) and insert the user identifier into a name of the corresponding unique messaging account. Accordingly, the transaction data extraction system 102 can generate the unique messaging account 306 to include an identifier for the payment card as well as an identifier for the corresponding user. In additional embodiments, for payment accounts involving a plurality of sub-accounts, the transaction data extraction system 102 can generate corresponding unique messaging accounts for the separate sub-accounts based on identifiers of the sub-accounts. Thus, using a payment card in connection with a particular sub-account can involve using a corresponding unique messaging account for the sub-account.

To further illustrate, in some embodiments, the transaction data extraction system 102 generates a unique name (e.g., address) for the unique messaging account 306 that includes one or more identifiers corresponding to the payment card 304, the payment account 302, the corresponding user(s), and/or other related information. For example, in some embodiments, the transaction data extraction system 102 generates a unique name that includes the card token or shard ID associated with the payment card 304 (e.g., an identifier indicating a specific server node that stores or processes data associated with a particular card program of the payment card 304). Further, in some embodiments, the unique name includes (or is based on) a specific user account, sub-account, or other identifier that associates the unique messaging account 306 accordingly. In some embodiments, for example, the transaction data extraction system 102 utilizes the following general format when generating a unique name of the unique messaging account 306: receipts-cardtoken-shard-id@domain.example.

As further shown in FIG. 3, when a card-based transaction 308 is initiated by the payment card 304 via a recipient computing system (e.g., a point-of-sale device, a payment application, or a webpage), the recipient system communicates with a payment network 312 to process data associated with the card-based transaction 308. For example, the recipient system determines a card number associated with the payment card 304 and a first subset of transaction data associated with the card-based transaction 308. The recipient system provides the card number and the first subset of transaction data to the payment network 312. In some embodiments, the card-based transaction 308 includes (or is associated with) a transaction identifier (“transaction ID 310”) that the recipient system generates in response to the card-based transaction 308 being initiated. In one or more alternative embodiments, the payment network 312 generates the transaction ID 310 for the card-based transaction 308 in response to receiving the card number and transaction data from the recipient system. In one or more embodiments, the transaction ID 310 identifies the card-based transaction 308 (and corresponding transaction data) for any computing device or system involved in processing the card-based transaction. The transaction ID 310 can include a serial number of other string of alpha-numeric characters for uniquely identifying the card-based transaction 308.

As mentioned, the transaction data extraction system 102 (and/or the card processing system) receives and exchanges various data with the payment network 312 in order to process the card-based transaction 308. As illustrated, for example, the transaction data extraction system 102 receives a transaction message 314 (or multiple transaction messages) from the payment network 312. In some embodiments, the transaction data extraction system 102 generates a transaction log of information from the transaction message 314 and/or other data received during (or otherwise in association with) processing of the card-based transaction 308. Specifically, the transaction data extraction system 102 generates the transaction log including a first subset of transaction data in response to extracting the first subset of transaction data from the transaction message 314.

As also shown in FIG. 3, in response to the card-based transaction 308 (e.g., in response to initiation, authorization, denial, and/or closing of the card-based transaction 308), the transaction data extraction system 102 receives a digital message 316 at the unique messaging account 306 corresponding to the payment card 304 (e.g., as described above in relation to FIG. 2). The digital message 316, for example, can include various information associated with the card-based transaction 308, such as a formal or informal receipt or digital invoice, a notification of shipment, merchant or product information, and so forth. As mentioned, in some embodiments, the transaction data extraction system 102 receives the digital message 316 from a recipient computing system or other system configured to issue invoices for card-based transactions. For instance, the recipient computing system communicates with a third-party system to generate digital messages for card-based transactions, such as via an integration between the recipient computing system and the third-party system.

In additional embodiments, in response to a card-swipe at a point-of-sale device or other transaction initiation action to initiate the card-based transaction 308 with the recipient computing system, the recipient computing system (or third-party system) detects the unique messaging account 306 assigned to the payment card 304. To illustrate, the recipient computing system detects the unique messaging account 306 based on a mapping between the payment card 304 and the unique messaging account 306 that the recipient computing system can access (e.g., via an API call from the recipient computing system to the transaction data extraction system 102). Alternatively, the recipient computing system can determine the unique messaging account 306 based on information that a point-of-sale device extracts from the payment card 304 in response to the card-based transaction 308.

In response to determining the unique messaging account 306 assigned to the payment card 304, the recipient computing system (or corresponding third-party system) generates the digital message 316 including the invoice data 318 and/or other data associated with the card-based transaction 308 (e.g., a second subset of transaction data) and sends the digital message 316 to the unique messaging account 306. Specifically, the recipient computing system (or third-party system) can utilize a messaging account associated with the recipient computing system to send the digital message 316 to the unique messaging account 306. Thus, the recipient computing system can send the digital message 316 to a unique email address, a unique text address, or to another unique messaging address associated with the payment card 304 and to which the transaction data extraction system 102 has access. In some embodiments, only the transaction data extraction system 102 has access to the unique messaging account 306 (e.g., to messages sent to the unique messaging account 306).

In some implementations, the transaction data extraction system 102 also provides the digital message 316 for display at a cardholder device. To illustrate, the transaction data extraction system 102 forwards the digital message 316 to a messaging account associated with the payment account 302, such as a user-specified email address, a text messaging phone number, an alternative messaging account, and/or a physical address (e.g., a billing address associated with the payment account 302). The cardholder can thus verify the details of the card-based transaction 308 that the transaction data extraction system 102 received from the recipient computing system.

In response to receiving the digital message 316 at the unique messaging account 306, the transaction data extraction system 102 determines (e.g., parses or extracts) the invoice data 318 from the digital message 316. In some embodiments, for example, the transaction data extraction system 102 utilizes a parsing script configured to extract the invoice data 318 from the digital message 316 received at the unique messaging account 306. For example, in some embodiments, the transaction data extraction system 102 implements a custom parsing script on a computing platform, such as but not limited to a cloud-based computing system, wherein the computing platform is configured to support the custom parsing script. For instance, in some embodiments, the transaction data extraction system 102 utilizes one or more libraries of a cloud-based computing system to generate a script that causes the system to listen for and parse the digital message 316 at the unique messaging account 306 to determine the invoice data 318.

Moreover, in some implementations, the transaction data extraction system 102 receives digital messages in various formats (e.g., invoices generated in different formats by different recipient systems/third-party systems) at the unique messaging account 306. Accordingly, in some embodiments, the transaction data extraction system 102 is configured to extract invoice data from digital messages provided in various formats to the unique messaging account 306. In some embodiments, for example, the transaction data extraction system 102 utilizes relevant keywords to search each digital message received and identify categories of information. In some embodiments, the transaction data extraction system 102 utilizes a trained machine learning model to identify, analyze, and extract invoice data from invoices of various formats.

Further, the transaction data extraction system 102 reconciles data from the transaction message 314 with the invoice data 318 for storage within the transaction database 322. In some embodiments, for example, the card-based transaction data extraction system 102 determines that the invoice data 318 corresponds to the card-based transaction 308 initiated with the payment card 304 by an identifier of the unique messaging account 306 (e.g., a character string included within an address of the unique messaging account 306). In some embodiments, the transaction data extraction system 102 determines an identifier for the payment card 304, such as a shard ID (e.g., an identifier of a specific database partition corresponding to a card program of the payment card 304) and/or card token, and matches information included within the invoice data 318 (e.g., merchant, time, amount) with data from the transaction message 314.

Specifically, the transaction message 314 and the invoice data 318 include at least some data that overlaps. For example, the transaction message 314 and the invoice data 318 include a recipient identifier associated with the recipient computing system, a transaction time of the card-based transaction, and a payment amount of the card-based transaction. The transaction data extraction system 102 can thus verify that the overlapping data in the transaction message 314 and the invoice data 318 matches prior to consolidating/combining the transaction data from the digital message 316 and the corresponding transaction log. Moreover, in some embodiments, the transaction data extraction system 102 identify mismatches between data entries in the transaction message 314 and the invoice data 318 and responsively take action to correct the discrepant entries and/or prevent subsequent errors. For example, the transaction data extraction system 102 can modify a parsing script utilized to identify data entries. In additional embodiments, the transaction data extraction system 102 provides a notification/recommendation to a third-party administrator from which the data was received indicating mismatches and/or providing instructions for correcting the mismatches (e.g., by fixing a cause of the mismatches).

Accordingly, the transaction data extraction system 102 generates a mapping between the transaction message 314 and the invoice data 318 within the transaction database 322, such that the transaction data 320 comprises both the transaction message 314 and the invoice data 318. As mentioned, in some embodiments, the transaction data extraction system 102 associates transaction data from the transaction message 314 (i.e., a first subset of transaction data) and transaction data from the invoice data 318 (i.e., a second subset of transaction data) with a transaction ID 310, thus mapping the various data within the transaction database 322. Furthermore, as mentioned, at least a portion of the second subset of transaction data from the invoice data 318 may also be different than the first subset of transaction data from the transaction message 314. For instance, the invoice data 318 may include additional details associated with the card-based transaction 308 not included in the transaction message 314 (e.g., due to PCI standards or other limitations of the payment network 312, recipient system, and/or transaction type), as described in more detail below with respect to FIG. 4.

In one or more embodiments, the transaction data extraction system 102 utilizes the transaction ID 310 generated for the card-based transaction 308 by the recipient computing system and transmitted to the payment network 312 (and subsequently to the transaction data extraction system 102 via the transaction message 314). Alternatively, the transaction data extraction system 102 generates a separate transaction identifier for generating the mapping between the transaction message 314 and the invoice data 318. The transaction data extraction system utilizes the transaction ID 310 to identify the card-based transaction 308 and the transaction data 320 within the transaction database 322. In some embodiments, as described in more detail below, the transaction data extraction system 102 utilizes the transaction data 320 for additional downstream operations.

As mentioned, in one or more embodiments, the transaction data extraction system 102 parses and consolidates transaction data from multiple sources for card-based transactions. For example, FIG. 4 illustrates the transaction data extraction system 102 extracting and consolidating subsets of transaction data via a plurality of separate processing pipeline branches. In particular, FIG. 4 illustrates that the transaction data extraction system 102 determines consolidated transaction data 414 from a transaction message 404 received from a payment network 402 and from a digital message 410 received from a recipient system or third party system at a unique messaging account 408.

As shown, the transaction data extraction system 102 receives the transaction message 404 (or multiple messages) from the payment network 402 and generates a transaction log 406 for the corresponding card-based transaction. In some embodiments, the transaction data extraction system 102 (or a card processing system including the transaction data extraction system 102) receives the transaction message 404 from the payment network 402 in response to the payment network 402 processing the corresponding card-based transaction. The transaction data extraction system 102 extracts a first subset of transaction data from the transaction message 404 and generates the transaction log 406 (or one or more entries within an existing transaction log) to include the first subset of transaction data. The transaction log 406 can thus include various information for the corresponding card-based transaction, such as but not limited to a date and time of the card-based transaction, a recipient name or identifier (e.g., a merchant name or other identifier provided by the payment network 402), a transaction amount, a transaction currency, a transaction type (e.g., credit/debit), and/or authorization data associated with the card-based transaction.

In addition, the transaction data extraction system 102 receives the digital message 410 for the card-based transaction at the unique messaging account 408 and parses invoice data 412 from the digital message 410. In particular, the transaction data extraction system 102 extracts a second subset of transaction data from the invoice data 412 of the digital message 410. The invoice data 412 can include various information for the corresponding card-based transaction, such as but not limited to a date and time of the card-based transaction, a recipient name or identifier (e.g., a merchant name or other identifier provided by an issuer of the digital message 410), a transaction amount, an itemized list of purchased products or services, and so forth. Moreover, in some implementations, the transaction data extraction system 102 extracts information from the digital message 410 that is not provided by the payment network 402 (i.e., not included within the transaction log 406), such as but not limited to categories/classifications of products or services, recipient categories/classifications, additional detail about the products received/services rendered or recipient of the card-based transaction, and so forth.

As further shown in FIG. 4, the transaction data extraction system 102 generates a mapping between the first subset of transaction data from the transaction log 406 and the second subset of transaction data from the invoice data 412 to persist consolidated transaction data 414 within a transaction database. For example, in some implementations, the transaction data extraction system 102 determines overlapping information in the transaction log 406 and the invoice data 412 to reconcile the first subset of transaction data with the second subset of transaction data. To illustrate, the transaction data extraction system 102 determines a payment card identifier based on the unique messaging account 408 (e.g., based on a first portion of an email name including a shard ID corresponding to a card program of the payment card and/or a card token corresponding to the payment card) assigned to the payment card or an identifier included within the digital message 410 to identify the payment card used for the card-based transaction corresponding to the digital message 410. In one or more embodiments, the transaction data extraction system 102 utilizes the payment card identifier to search for recent transactions in the transaction log 406 (or other transaction history) for the identified payment card. The transaction data extraction system 102 can compare the most recent transactions in the transaction log 406 with the invoice data 412 to determine whether the first subset of transaction data and the second transaction data match (e.g., according to the respective transaction date/time, recipient ID, and transaction amount). Also, in response to determining that the transaction data in the transaction log 406 matches the transaction data in the invoice data 412, the transaction data extraction system 102 associates a transaction identification number (i.e., transaction ID) 416 with the consolidated transaction data 414 within the transaction database.

In one or more additional embodiments, the transaction data extraction system 102 stores the first subset of transaction data in a temporary file or database entry, as well as storing the first subset of transaction data in the transaction log 406 (e.g., separately from the transaction log 406). For example, the transaction data extraction system 102 can generate a temporary file including the transaction date/time of the card-based transaction and/or the recipient ID in the filename. Alternatively, the transaction data extraction system 102 can generate the temporary file with a randomly generated filename. In response to receiving the invoice data 412 and extracting the second subset of transaction data, the transaction data extraction system 102 can compare the second subset of transaction data to the first subset of transaction data in the temporary file to detect a match. In response to detecting a match between the subsets of transaction data, the transaction data extraction system 102 can commit the consolidated transaction data 414 to the transaction database and delete the temporary file.

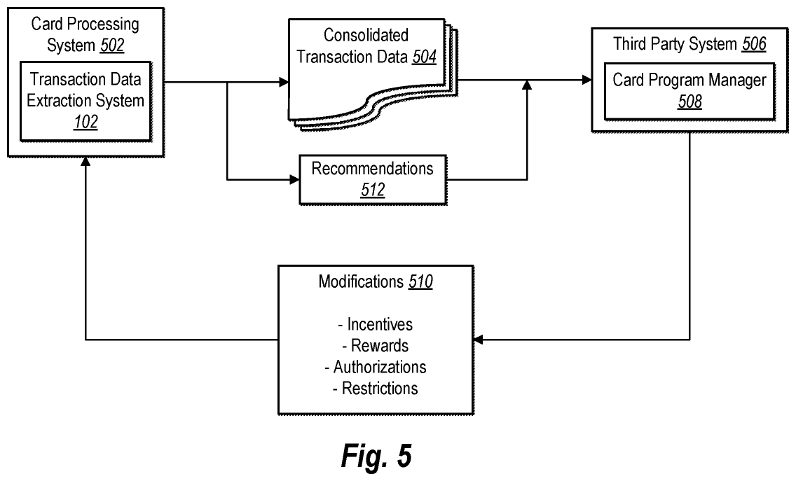

As mentioned, in one or more embodiments, the transaction data extraction system 102 utilizes consolidated transaction data from card-based transactions to perform additional downstream operations, such as determining modifications to a payment account associated with a payment card. For example, FIG. 5 illustrates the transaction data extraction system 102 determining and implementing one or more modifications 510 based on consolidated transaction data 504 for card-based transactions initiated by a payment card associated with a payment account.

As shown in FIG. 5, a card processing system 502 (or the transaction data extraction system 102) transmits (or otherwise provides access to) the consolidated transaction data 504 to a third party system 506. The third party system 506, for example, can include a computing system and/or network associated with a card program manager 508 of the payment card corresponding to the consolidated transaction data 504. The card program manager 508, for example, can include a program or entity authorized to make modifications to features of a payment card according to a card program to which the payment card belongs. In one or more embodiments, the third party system 506 includes a computing system that manages funds or ledgers associated with payment cards corresponding to the card program.

As used herein, the term “card program” refers to software and data that determines when and how one or more payment cards (or accounts) can be used to engage in payment transactions. For example, a card program includes a plurality of parameter configurations that define attributes of an account associated with the card program including, but not limited to, pricing (e.g., annual percentage rate), fees, usage locations, rewards, discounts, or other attributes. Accordingly, different card programs that have different parameter configurations provide different usage, benefits, etc., to users of cards/accounts corresponding to the different card programs. In some embodiments, a card program includes one or more payment cards associated with one or more users and provides settings for utilizing payment cards to initiate payment transactions. In additional embodiments, a payment card/account includes one or more processing parameters with one or more parameter ranges for processing transactions involving the payment card/account.

As further illustrated in FIG. 5, in response to determining (and analyzing) the consolidated transaction data 504, the transaction data extraction system 102 determines one or more recommendations 512 of modifications to the payment card and/or payment account. The one or more recommendations 512, for example, can include various incentives, rewards, authorizations, or restrictions to the payment account/card for subsequent transactions and related account/card activity. To illustrate, the one or more recommendations 512 include a change in a reward rate in connection with a particular product category or recipient category. Alternatively, the one or more recommendations 512 can include a restriction on transactions involving the payment card for specific product categories or recipient categories.

The transaction data extraction system 102 can send the one or more recommendations 512 to the third party system 506 for implementation via the card program manager 508. In particular, in response to receiving the one or more recommendations 512 from the transaction data extraction system 102, the third party system 506 can utilize the card program manager 508 to change settings or parameters associated with a card program of the payment card and/or payment account. To illustrate, the third party system 506 can utilize the card program manager 608 to generate one or more modifications 510 to the payment card or payment account, which can dictate how the card processing system 502 processes subsequent card-based transactions involving the payment card/payment account.

Further, according to one or more embodiments, the transaction data extraction system 102 can provided consolidated transaction data for a subsequent transaction to enable accurate implementation of the modifications 510 (e.g., as described below in relation to FIG. 6). Specifically, in response to extracting transaction data for a subsequent transaction involving the payment card, the transaction data extraction system 102 can provide consolidated transaction data to the third party system 506 to verify handling of one or more portions of the consolidated transaction data in line with the modified card program. For example, the transaction data extraction system 102 can communicate with the third party system 506 to verify that one or more portions of a card-based transaction apply to a first sub-account with a first setting modified by the one or more modifications 510 and that one or more portions of the card-based transaction apply to a second sub-account with a second setting unmodified by the one or more modifications 510.

Although FIG. 5 illustrates that the transaction data extraction system 102 provides the one or more recommendations 512 to the third party system 506 to generate the one or more modifications 512, in alternative embodiments, the transaction data extraction system 102 generates modifications for a payment card. For example, the transaction data extraction system 102 can provide the modifications to the third party system 506 (rather than recommendations), which causes the third party system 506 to modify one or more parameters of the payment account. Alternatively, the transaction data extraction system 102 can modify settings associated with a payment card at the card processing system 502 in connection with determining whether to process certain card-based transactions according to the modifications. To illustrate, the transaction data extraction system 102 can maintain an account history associated with the payment card to enforce spending limits, time limits, or location restrictions for one or more product categories or recipients (e.g., according to recipient identifiers, categories, or locations). The transaction data extraction system 102 can communicate with the card processing system 502 to enforce such restrictions, such as by communicating with a payment network during processing of a card-based transaction prior to authorizing the transaction with the third party system 506.

As mentioned, in one or more embodiments, the transaction data extraction system 102 utilizes transaction data from one or more sources to determine authorization of a card-based transaction for a category-restricted payment card. For example, FIG. 6 illustrates the transaction data extraction system 102 authorizing a card-based transaction initiated by a payment card 610 associated with a category-restricted sub-account 608 of a payment account 606. Specifically, the transaction data extraction system 102 considers transaction data 620 in determining whether a requested payment complies with one or more rules established by a card program manager 604.

Moreover, in some embodiments, the transaction data extraction system 102 generates, based on the transaction data 620, a modification to the category-restricted sub-account 608. For example, in certain implementations, an authorization to utilize funds from the category-restricted sub-account may be unavailable at the time of payment due to a delay in receiving additional data needed for such authorization (e.g., an itemized list of products and services). Under such circumstances, for example, transaction data extraction system 102 can authorize the use of funds from the payment account 606 at the time of transaction, then modify the balance of the category-restricted sub-account after the additional information is received. Further, in some implementations, the transaction data extraction system 102 can generate a modification to the rules or settings for use of funds from the category-restricted sub-account based on the additional data received during or after the transaction. In additional embodiments, the transaction data extraction system 102 determines whether to modify a balance of the category-restricted sub-account 608 based on the transaction data 620 (e.g., via the use of an intermediate account associated with the payment account 606).

As illustrated, the payment account 606 includes the category-restricted sub-account 608, the category-restricted sub-account 608 being linked to the payment card 610. To further illustrate, the category-restricted sub-account 608 is supported by collateral assets 602. For instance, in some embodiments, the category-restricted sub-account 608 comprises a home equity line of credit provided and managed by the card program manager 604. In such case, the collateral assets 602 may include a home or other real estate holding provided to the card program manager 604 as collateral for an open line of credit. In other implementations, the category-restricted sub-account 608 comprises alternative types of accounts, such as but not limited to a health savings account, a trust fund with established rules for withdrawal, and so forth.

In some embodiments, the card program manager 604 establishes and/or provides rules and parameters for use of funds from the category-restricted sub-account 608. Further, use of the payment card 610, issued by the card program manager 604 or another entity associated with the card program manager 604 to provide convenient access to the category-restricted sub-account 608, is restricted according to one or more established rules. For example, for a home equity line of credit, the category-restricted sub-account 608 can be restricted to goods and services related to home improvement. For a health savings account, the category-restricted sub-account 608 can be restricted to goods and services related to healthcare and wellbeing. Moreover, in one or more embodiments, the transaction data extraction system 102 determines and consolidates transaction data for card-based transactions initiated by the payment card 610 and utilizes the transaction data to determine which purchases qualify as tax-deductible according to the established rules.

As shown in FIG. 6, in response to a payment initiation 612 at a recipient device 616 (e.g., a point-of-sale device or online purchasing portal) utilizing the payment card 610, the recipient device 616 communicates with a payment network 614 to process the initiated transaction. In response, the payment network 614 issues a transaction authorization request 618 for the initiated transaction. A card processing system 622 considers (i.e., analyzes) transaction data 620 associated with the transaction authorization request 618 to determine one or more characteristics of the initiated transaction, such as but not limited to line item details from the initiated transaction including categories/classifications of products or services, merchant categories/classifications, purchase quantities and costs, and so forth. In some implementations, the card processing system 622 receives additional data from the recipient device 616, such as a digital message (e.g., as described above in relation to FIGS. 2-4), and consolidates the additional data with the transaction data from the payment network 614.

In one or more embodiments, in accordance with the one or more rules established by the card program manager 604 for the category-restricted sub-account 608, the card processing system 622 determines whether to authorize the initiated transaction. In such instances that the transaction is authorized, the card processing system 622 transmits authorization and/or payment to the recipient device by the payment network 614. Alternatively, in some embodiments, the card processing system 622 communicates with a third-party system (e.g., associated with the card program manager 604) that handles funds or ledgers for the payment account 606 to authorize the payment transaction based on the consolidated transaction data and responds to the payment network 614 with authorization of the payment transaction.

In alternative embodiments, instead of utilizing the consolidated transaction data in connection with authorizing the transaction, the card processing system 622 utilizes the consolidated transaction data to determine how to fund the card-based transaction. In particular, the card processing system 622 may authorize the transaction for the payment account 606 based on funds in the payment account 606 (e.g., in one or more sub-accounts) and utilize the consolidated transaction data to determine whether to draw the funds from the category-restricted sub-account 608 or from another account. For instance, in response to determining that the consolidated transaction data indicates that the transaction complies with the rules corresponding to the category-restricted sub-account 608 (e.g., product categories all fall within specific home improvement categories), the card processing system 622 can determine to fund the transaction utilizing the category-restricted sub-account 608. Alternatively, in response to determining that at least a portion of the transaction does not comply with the rules for the category-restricted sub-account 608, the card processing system 622 can determine to fund the non-compliant portions of the transaction with one or more other sub-accounts of the payment account 606 as long as the one or more other sub-accounts include sufficient funds. In further embodiments, the card processing system 622 (or the transaction data extraction system 102) generates a report based on the consolidated transaction data to provide to a user device of a cardholder of the payment card 610 for the cardholder records, tax purposes, etc.

Moreover, in some embodiments, the card processing system 622 utilizes the consolidated transaction data extracted by the transaction data extraction system 102 to monitor for fraudulent activity. In some implementations, for example, the card processing system 622 (or the transaction data extraction system 102) identifies mismatching data between the invoice data and the transaction data for a particular transaction and, in response, notifies the card program manager 508, the user, and/or another third-party system. Further, the card processing system 622 can utilize the consolidated transaction data to determine a location where the fraudulent activity occurred (e.g., by identifying the location of the recipient and/or the IP address at which the payment card was used). Also, in some embodiments, the card processing system 622 (or the transaction data extraction system 102) monitors transaction patterns across various transaction initiated with the same payment card and identifies potentially fraudulent activity in response to unsubstantiated changes in such patterns. To illustrate, the transaction data extraction system 102 can detect fraudulent activity in response to determining that certain product categories, merchant categories, and/or transaction times extracted from invoice data do not align with product categories in a purchase history for a payment card.

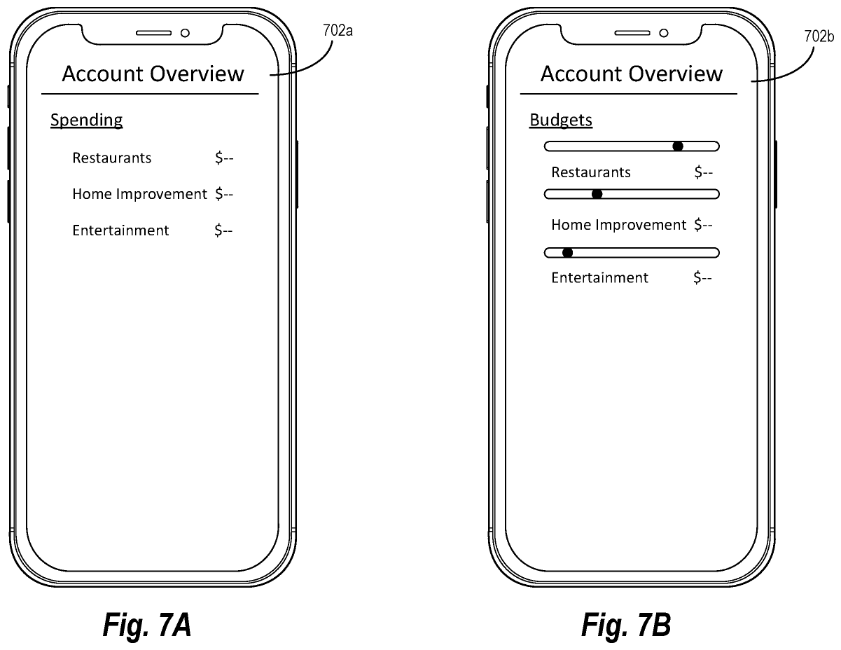

As mentioned, in one or more embodiments, the transaction data extraction system 102 extracts, consolidates, and stores transaction data for card-based transactions initiated by a payment card and provides various user interfaces and financial tools in accordance with the consolidated transaction data. For example, FIGS. 7A-7B provide two illustrative examples of user interfaces of client devices displaying information based on transaction data consolidated and stored by the transaction data extraction system 102 for a payment account comprising at least one payment card.

For instance, FIG. 7A shows a user interface 702a of a client device of a cardholder or other user associated with a payment card. As shown, the client device displays the user interface 702a including a summary of spending associated with multiple categories of goods and services. Indeed, the transaction data extraction system 102 can provide monitoring of transaction data with increased accuracy, such that budgets are accurately and efficiently tracked and presented to a user. Accordingly, the transaction data extraction system 102 can categorize individual line items in card-based transactions based on consolidated transaction data (e.g., including subsets of transaction data from a payment network and from digital messages) extracted in connection with the card-based transactions. The transaction data extraction system 102 can thus generate and provide categorized spending information for a payment card for display at the client device.

Relatedly, FIG. 7B shows a user interface 702b of the client device. As shown, the user interface 702b includes adjustable features (e.g., slider bars) for multiple categories of goods and services. Accordingly, in some embodiments, a user can adjust one or more budgets corresponding to one or more categories of goods and services by interacting with graphical elements displayed within the user interface 702 via the client device. The client device can communicate the one or more budgets to the transaction data extraction system 102 for associating with the payment card. In response, the transaction data extraction system 102 can monitor spending in each respective category and, in some implementations, provide notification to the user (e.g., via the client device) when budgets are exceeded (or reach a threshold percentage of the specified budget amount). In some implementations, the transaction data extraction system 102 can lock (i.e., disable) a payment card when a budget is reached or exceeded and provide a notification indicating the restriction for display at the client device.

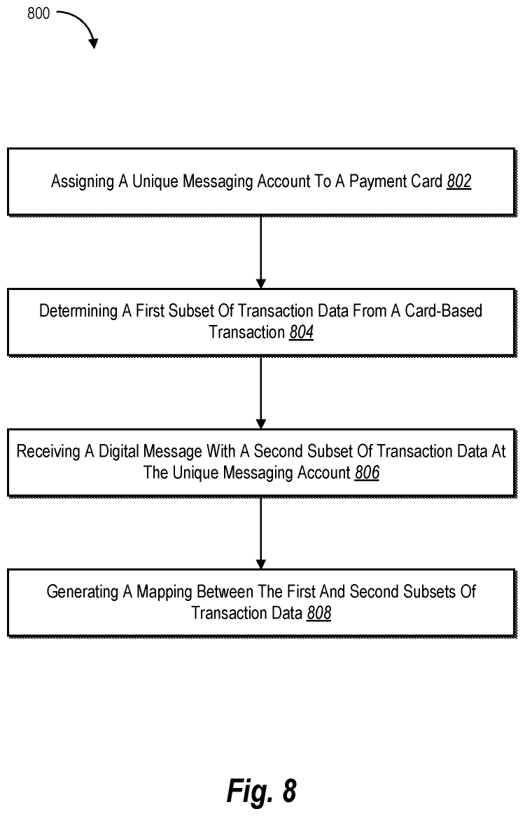

Turning now to FIG. 8, this figure shows a flowchart of a series of acts 800 of retrieving and consolidating transaction data for a card-based transaction initiated by a payment card. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions, that when executed by one or more processors, cause a computing device to perform the acts of FIG. 8. In still further embodiments, a system can perform the acts of FIG. 8.

As shown in FIG. 8, the series of acts 800 includes an act 802 of assigning a unique messaging account to a payment card. For example, in some embodiments, the act 802 includes assigning, by at least one processor of a card processing system, a unique messaging account to a payment card associated with a payment account. Further, in some embodiments, assigning the unique messaging account to the payment card comprises generating a dedicated email address, a dedicated text messaging number, or a dedicated instant messaging account for the payment card.

As shown, the series of acts 800 also includes an act 804 of determining a first subset of transaction data from a card-based transaction. For example, in some embodiments, the act 804 includes determining, by the at least one processor of the card processing system in response to a card-based transaction initiated using the payment card, a first subset of transaction data corresponding to the card-based transaction. Further, in some embodiments, determining the first subset of transaction data corresponding to the card-based transaction comprises generating a transaction log for the card-based transaction based on a transaction message received from a payment network utilized to process the card-based transaction.

Additionally, the series of acts 800 includes an act 806 of receiving a digital message with a second subset of transaction data at the unique messaging account. For example, in some embodiments, the act 806 includes receiving, by the at least one processor of the card processing system and from an electronic messaging system in response to the card-based transaction, a digital message comprising a second subset of transaction data corresponding to the card-based transaction at the unique messaging account assigned to the payment card. Further, in some embodiments, receiving the digital message from the electronic messaging system comprises receiving a message from a third-party system and extracting the digital message from the message. Also, in some embodiments, receiving the message from the third-party system comprises receiving the message from a recipient computing system or an additional computing system in communication with the recipient computing system.

Moreover, in one or more embodiments, the act 806 includes determining, in response to receiving the digital message, additional data not included in first subset of transaction data. In some embodiments, the additional data comprises one or more of a product classification, a recipient type, or an itemized list of purchased products. Also, in one or more embodiments, the act 806 includes generating, based on the additional data, an authorization for the payment account to utilize a category-restricted sub-account to complete the card-based transaction.

As shown, the series of acts 800 further includes an act 808 of generating a mapping between the first and second subsets of transaction data. For example, in some embodiments, the act 808 includes generating, by the at least one processor of the card processing system in response to receiving the digital message at the unique messaging account, a mapping between the second subset of transaction data of the digital message and the first subset of transaction data within a transaction database. Further, in some embodiments, generating the mapping comprises generating, within the transaction database, a database entry comprising the first subset of transaction data, the second subset of transaction data, and a transaction identification number corresponding to the card-based transaction. Additionally, in one or more embodiments, the act 808 includes determining, in response to receiving the digital message at the unique messaging account, the payment card based on information extracted from an identifier of the unique messaging account.

Moreover, in some embodiments, generating the mapping between the second subset of transaction data of the digital message and the first subset of transaction data comprises associating the digital message with the card-based transaction by matching one or more of a merchant identifier, a time of transaction, or a payment amount within the first subset of transaction data and the second subset of transaction data. Also, in one or more embodiments, generating the mapping comprises associating the first subset of transaction data and the second subset of transaction data with a transaction identification number within the transaction database. Further, in some embodiments, generating the mapping comprises combining the first subset of transaction data and the second subset of transaction data in a database entry within the transaction database utilizing a transaction identifier corresponding to the card-based transaction.

While not shown in FIG. 8, the series of acts 800 can further include receiving, from an account management system, a request for the first subset of transaction data. The series of acts 800 can also include providing, utilizing the mapping between the between the second subset of transaction data and the first subset of transaction data, the second subset of transaction data with the first subset of transaction data to the account management system. Further, in some embodiments, the series of acts 800 includes transmitting, in response to generating the mapping, at least a portion of the second subset of transaction data to an account management system.

Also, in some embodiments, the series of acts 800 includes tracking usage of the payment card associated with the payment account according to a set of rules for the payment card based on the first subset of transaction data and the second subset of transaction data corresponding to the card-based transaction. Further, in some embodiments, the series of acts 800 includes detecting fraudulent activity associated with the payment account based on the first subset of transaction data and the second subset of transaction data corresponding to the card-based transaction.

Moreover, in one or more embodiments, the series of acts 800 includes determining, based on the first subset of transaction data and the second subset of transaction data according to the mapping, one or more modifications for the payment account in connection with a card program of the payment account. Also, the series of acts 800 can include modifying one or more parameters of the payment account by providing the one or more modifications for the payment account to a third-party system associated with the card program of the payment account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 that may be configured to perform one or more of the processes described above. One will appreciate that one or more computing devices such as the computing device 900 may implement the system(s) of FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. In certain embodiments, the computing device 900 can include fewer or more components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions for dynamically modifying workflows, the processor 902 may retrieve (or fetch) the instructions from an internal register, an internal cache, the memory 904, or the storage device 906 and decode and execute them. The memory 904 may be a volatile or non-volatile memory used for storing data, metadata, and programs for execution by the processor(s). The storage device 906 includes storage, such as a hard disk, flash disk drive, or other digital storage device, for storing data or instructions for performing the methods described herein.

The I/O interface 908 allows a user to provide input to, receive output from, and otherwise transfer data to and receive data from computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 910 may facilitate communications with various types of wired or wireless networks. The communication interface 910 may also facilitate communications using various communication protocols. The communication infrastructure 912 may also include hardware, software, or both that couples components of the computing device 900 to each other. For example, the communication interface 910 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

1. A computer-implemented method comprising:
generating, by at least one processor of a card processing system in response to receiving permission to obtain invoice data for future transactions initiated using a particular payment card associated with a payment account, a unique messaging account exclusively dedicated to the particular payment card, the card processing system having direct access to the unique messaging account generated for the particular payment card;
determining, by the at least one processor of the card processing system in response to a card-based transaction initiated via a payment network using the particular payment card, a first subset of transaction data comprising transaction-specific data for the card-based transaction transmitted by the payment network;
providing, by the at least one processor of the card processing system, an address of the unique messaging account generated for the particular payment card to a payment recipient system or a third-party system associated with the payment recipient system;
receiving, at the unique messaging account generated for the particular payment card, a digital message from the payment recipient system or the third-party system associated with the payment recipient system via an electronic messaging system in response to the card-based transaction;
determining, by the at least one processor of the card processing system and from the digital message, a second subset of transaction data comprising invoice data for the card-based transaction; and
generating, by the at least one processor of the card processing system, a mapping between the second subset of transaction data of the digital message and the first subset of transaction data within a transaction database.

2. The computer-implemented method of claim 1, wherein determining the first subset of transaction data corresponding to the card-based transaction comprises generating a transaction log for the card-based transaction based on a transaction message received from the payment network utilized to process the card-based transaction.

3. The computer-implemented method of claim 1, wherein receiving the digital message via the electronic messaging system comprises receiving a message from the third-party system associated with the payment recipient system to the unique messaging account exclusively dedicated to the particular payment card and extracting the digital message from the message.

4. The computer-implemented method of claim 3, wherein receiving the message from the third-party system comprises receiving the message from a recipient computing system or an additional computing system in communication with the recipient computing system.

5. The computer-implemented method of claim 1, further comprising determining, from the digital message, additional data not included in the first subset of transaction data transmitted by the payment network.

6. The computer-implemented method of claim 5, wherein the additional data comprises one or more of a product classification, a recipient type, or an itemized list of purchased products.

7. The computer-implemented method of claim 6, further comprising generating, based on the additional data, a modification to a category-restricted sub-account of the payment account.

8. The computer-implemented method of claim 1, wherein generating the mapping comprises generating, within the transaction database, a database entry comprising the first subset of transaction data, the second subset of transaction data, and a transaction identification number corresponding to the card-based transaction.

9. The computer-implemented method of claim 1, further comprising:
receiving, from an account management system, a request for the first subset of transaction data; and
providing, utilizing the mapping between the second subset of transaction data and the first subset of transaction data, the second subset of transaction data with the first subset of transaction data to the account management system.

10. A system comprising:
one or more non-transitory computer readable media; and
at least one processor configured to cause the system to:
generate, via a card processing system in response to receiving permission to obtain invoice data for future transactions initiated using a particular payment card associated with a payment account, a unique messaging account exclusively dedicated to the particular payment card, the card processing system having direct access to the unique messaging account generated for the particular payment card;
determine, in response to a card-based transaction initiated via a payment network using the particular payment card, a first subset of transaction data comprising transaction-specific data for the card-based transaction transmitted by the payment network;
provide an address of the unique messaging account generated for the particular payment card to a payment recipient system or a third-party system associated with the payment recipient system;
receive, at the unique messaging account generated for the particular payment card, a digital message from the payment recipient system or the third-party system associated with the payment recipient system via an electronic messaging system in response to the card-based transaction;
determine, from the digital message, a second subset of transaction data comprising invoice data for the card-based transaction; and
generate a mapping between the second subset of transaction data of the digital message and the first subset of transaction data within a transaction database.

11. The system of claim 10, wherein generating the unique messaging account for the particular payment card comprises generating, by the at least one processor, a dedicated email address, a dedicated text messaging number, or a dedicated instant messaging account for the particular payment card.

12. The system of claim 10, wherein the at least one processor is further configured to cause the system to determine, in response to receiving the digital message at the unique messaging account, the particular payment card based on information extracted from an identifier of the unique messaging account generated for the particular payment card.

13. The system of claim 12, wherein generating the mapping between the second subset of transaction data of the digital message and the first subset of transaction data comprises associating the digital message with the card-based transaction by matching one or more of a merchant identifier, a time of transaction, or a payment amount within the first subset of transaction data and the second subset of transaction data.

14. The system of claim 13, wherein generating the mapping comprises associating the first subset of transaction data and the second subset of transaction data with a transaction identification number within the transaction database.

15. The system of claim 14, wherein the at least one processor is further configured to cause the system to transmit, in response to generating the mapping, at least a portion of the second subset of transaction data to an account management system.

16. A non-transitory computer readable medium comprising instructions that, when executed by at least one processor, cause the at least one processor to:
generate, via a card processing system in response to receiving permission to obtain invoice data for future transactions initiated using a particular payment card associated with a payment account, a unique messaging account exclusively dedicated to the particular payment card, the card processing system having direct access to the unique messaging account generated for the particular payment card;
determine, in response to a card-based transaction initiated via a payment network using the particular payment card, a first subset of transaction data comprising transaction-specific data for the card-based transaction transmitted by the payment network;
provide an address of the unique messaging account generated for the particular payment card to a payment recipient system or a third-party system associated with the payment recipient system;
receive, at the unique messaging account generated for the particular payment card, a digital message from the payment recipient system or the third-party system associated with the payment recipient system via an electronic messaging system in response to the card-based transaction;
determine, from the digital message, a second subset of transaction data comprising invoice data for the card-based transaction; and
generate a mapping between the second subset of transaction data of the digital message and the first subset of transaction data within a transaction database.

17. The non-transitory computer readable medium of claim 16, wherein generating the mapping comprises combining the first subset of transaction data and the second subset of transaction data in a database entry within the transaction database utilizing a transaction identifier corresponding to the card-based transaction.

18. The non-transitory computer readable medium of claim 16, further comprising instructions that, when executed by the at least one processor, cause the at least one processor to track usage of the particular payment card associated with the payment account according to a set of rules for the particular payment card based on the first subset of transaction data and the second subset of transaction data corresponding to the card-based transaction.

19. The non-transitory computer readable medium of claim 16, further comprising instructions that, when executed by the at least one processor, cause the at least one processor to detect fraudulent activity associated with the payment account based on the first subset of transaction data and the second subset of transaction data corresponding to the card-based transaction.

20. The non-transitory computer readable medium of claim 16, further comprising instructions that, when executed by the at least one processor, cause the at least one processor to:
determine, based on the first subset of transaction data and the second subset of transaction data according to the mapping, one or more modifications for the payment account in connection with a card program of the payment account; and
modify one or more parameters of the payment account by providing the one or more modifications for the payment account to a third-party system associated with the card program of the payment account.
